(19) United States
(12) Patent Application Publication
(10) Pub. No.: US 2026/0087358 A1
(43) Pub. Date: Mar. 26, 2026

(54) DEEP REINFORCEMENT LEARNING FRAMEWORK

(71) Applicant: Korea University of Technology And Education Industry-University Cooperation Foundation, Cheonan-si (KR)

(72) Inventors: Won Tae KIM, Cheonan-si (KR); Deun Sol CHO, Cheonan-si (KR); Jae Min CHO, Cheonan-si (KR); Min Cheol LEE, Cheonan-si (KR)

(73) Assignee: Korea University of Technology And Education Industry-University Cooperation Foundation, Cheonan-si (KR)

(21) Appl. No.: 18/955,761

(22) Filed: Nov. 21, 2024

(30) Foreign Application Priority Data
Sep. 25, 2024 (KR) 10-2024-0130073

(51) Int. Cl. G06N 3/092

(52) U.S. Cl. CPC G06N 3/092

(57) ABSTRACT

A deep reinforcement learning framework according to an embodiment may include a reinforcement learning environment that provides an environment with which an agent may interact; a policy network that learns an optimal policy through trial and error in which the agent selects an action based on a given state in the reinforcement learning environment and obtains a reward as a result of the action; a memory for reproduction that stores information about a state, action, reward, and next state generated by the agent interacting with the reinforcement learning environment; an extrinsic uncertainty recognition unit that determines extrinsic uncertainty based on the agent's metacognitive ability and detects a new state to provide an additional exploration reward; an intrinsic uncertainty recognition unit that evaluates intrinsic uncertainty of transactions generated by the policy network; an uncertainty data filtering unit that selects a transaction with high uncertainty based on an evaluation result of the intrinsic uncertainty recognition unit; and a memory for reproduction reconstruction unit that reconstructs the memory for reproduction based on the selected transaction to optimize repeated learning of the agent.

### CROSS-REFERENCE TO RELATED APPLICATION

The present application claims priority under 35 U.S.C. § 119(a) to Korean Patent Application No. 10-2024-0130073, filed on Sep. 25, 2024, which is incorporated herein by reference in its entirety.

### BACKGROUND

### 1. Field

One or more embodiments relate to a deep reinforcement learning (DRL) framework from among artificial intelligence (AI) and machine learning (ML), and more particularly, to a method of developing metacognitive ability, which is an important element of self-directed learning methods, based on the concept of uncertainty and applying it to reinforcement learning.

### 2. Description of the Related Art

Reinforcement learning is one of the important research topics in the field of artificial intelligence and machine learning, and is used to develop a system that learns optimal actions on its own in a given environment. This technique involves a process in which an agent learns what consequences result from choosing an action in each situation while interacting with an environment.

In general, in reinforcement learning, an agent accumulates experience through repeated interactions with an environment, learns from that experience, and improves action policies. In this process, the agent gradually discovers an optimal action policy by using rewards provided by the environment for specific actions. This learning process may be applied to various fields of application, and is utilized in robotics, game artificial intelligence, autonomous driving, financial modeling, etc.

An important characteristic of reinforcement learning is that an agent may autonomously learn through interactions with an environment without prior knowledge. Through this, the agent acquires the ability to effectively deal with complex problem situations that are difficult to predict.

The above information may be provided as related art for the purpose of helping to understand the disclosure. No claim or determination is made as to whether any of the above contents can be applied as prior art related to the disclosure.

### SUMMARY

A deep reinforcement learning framework according to an embodiment may include a reinforcement learning environment that provides an environment with which an agent may interact; a policy network that learns an optimal policy through trial and error in which the agent selects an action based on a given state in the reinforcement learning environment and obtains a reward as a result of the action; a memory for reproduction that stores information about a state, action, reward, and next state generated by the agent interacting with the reinforcement learning environment; an extrinsic uncertainty recognition unit that determines extrinsic uncertainty based on the agent's metacognitive ability and detects a new state to provide an additional exploration reward; an intrinsic uncertainty recognition unit that evaluates intrinsic uncertainty of transactions generated by the policy network; an uncertainty data filtering unit that selects a transaction with high uncertainty based on an evaluation result of the intrinsic uncertainty recognition unit; and a memory for reproduction reconstruction unit that reconstructs the memory for reproduction based on the selected transaction to optimize repeated learning of the agent.

The extrinsic uncertainty recognition unit may calculate a reconstruction error using an auto-encoder to detect the new state from the given state by the agent, and if the reconstruction error is large, the given state may be determined as the new state and the additional exploration reward may be provided.

The intrinsic uncertainty recognition unit may evaluate the degree of confidence in each action of the transactions generated by the policy network using a Monte-Carlo dropout technique or an ensemble technique.

The memory for reproduction may periodically store information about the state, action, reward, and next state generated by the agent interacting with the reinforcement learning environment, and the stored information may be readjusted in priority by the memory for reproduction reconstruction unit.

The policy network may learn an action policy in real time based on the reward obtained by the agent in the reinforcement learning environment and the additional exploration reward.

The transaction stored in the memory for reproduction is reconstructed by the memory for reproduction reconstruction unit and then repeatedly trained in the policy network so that the action policy of the agent may be optimized.

The uncertainty data filtering unit may filter the transaction according to an evaluation result of the intrinsic uncertainty recognition unit, and may preferentially transmit the transaction with high-uncertainty to the memory for reproduction reconstruction unit.

The intrinsic uncertainty recognition unit and the extrinsic uncertainty recognition unit according to an embodiment may cooperate to use a weight adjustment technique based on multiple uncertainties, and the weight adjustment technique may dynamically adjust a learning speed and learning weight of the policy network according to levels of the intrinsic uncertainty and extrinsic uncertainty so as to optimize the agent's action policy so that exploration may be performed more effectively in a state of high uncertainty.

### BRIEF DESCRIPTION OF DRAWINGS

FIG. 1 is a view for explaining reinforcement learning according to an embodiment.

FIG. 2 is a view for explaining a reinforcement learning system according to an embodiment.

FIG. 3 is a block diagram of a deep reinforcement learning framework according to an embodiment.

FIG. 4 is a view illustrating a structure of a deep reinforcement learning framework according to an embodiment.

FIG. 5 is a flowchart explaining a reinforcement learning method according to an embodiment.

FIG. 6 is a block diagram of an electronic device according to an embodiment.

### DETAILED DESCRIPTION

Hereinafter, embodiments of the present invention will be described with reference to the drawings. In the following description, descriptions of a well-known technical configuration in relation to a lead implantation system for a deep brain stimulator will be omitted. For example, descriptions of the configuration/structure/method of a device or system commonly used in deep brain stimulation, such as the structure of an implantable pulse generator, a connection structure/method of the implantable pulse generator and a lead, and a process for transmitting and receiving electrical signals measured through the lead with an external device, will be omitted. Even if these descriptions are omitted, one of ordinary skill in the art will be able to easily understand the characteristic configuration of embodiments of the present invention through the following description.

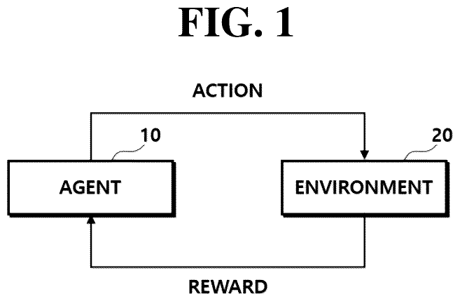

FIG. 1 is a view for explaining reinforcement learning according to an embodiment.

Referring to FIG. 1, a reinforcement learning model according to an embodiment may include an agent 10 and an environment 20 as main components. Reinforcement learning is a machine learning technique in which the agent 10 interacts with the environment 20 and learns optimal actions. Hereinafter, reinforcement learning may be used as a concept including deep reinforcement learning.

The agent 10 observes various states within the environment 20 and selects actions that can be taken in the corresponding states. In this process, the agent 10 changes the environment 20 through actions and receives rewards from the environment 20 accordingly.

The agent 10 continuously learns to maximize this reward and improves future actions based on past experiences. In more detail, the agent 10 learns which actions are more likely to receive a high reward when the agent 10 is in a specific state in the environment 20. This process is repeated over time, and the agent 10 gradually develops an optimal policy.

The core of reinforcement learning is to understand how the agent 10 learns and adjusts its action through interactions between the agent 10 and the environment 20. A reward received from the environment 20 is a standard for evaluating the quality of an action selected by the agent 10, and this information plays an important role in learning of the agent 10.

Because the agent 10 performs exploration and exploitation on its own, it is very effective in learning a complex state space. The exploration is a process in which the agent 10 attempts various actions to obtain learning information, and the exploitation is a process of reinforcing an action strategy based on the obtained information.

However, reinforcement learning defines that the agent 10 learns a given task by itself through trial and error, but there is a limitation that even if the agent 10 learns through passive trial and error based on probability, it is not possible to be certain about results obtained through learning.

Research is actively being conducted to incorporate curriculum learning to smoothly guide learning of a deep reinforcement learning agent in a vast exploitation space. Curriculum learning sequentially trains a deep reinforcement learning agent from low-difficulty exploitation spaces to high-difficulty exploitation spaces so that the deep reinforcement learning agent may successfully complete learning without overfitting in a vast exploitation space. However, this method is teacher-directed learning, which essentially defines an agent as a passive entity, and is not a method in which the agent learns on its own. In other words, when a curriculum derived by a teacher is poorly designed or is not suitable for a learner, it may have a negative effect on the learner's learning.

As will be explained in detail below, a reinforcement learning method according to an embodiment allows learners to autonomously realize how to efficiently explore a new state space that is not a defined curriculum and what is lacking in learning, and provide feedback on this. The reinforcement learning method according to an embodiment is about a method for applying a self-directed learning method to reinforcement learning, and more particularly, is about a method for developing metacognitive ability, which is an important element of self-directed learning methods, based on the concept of uncertainty and grafting it onto reinforcement learning.

The concept of self-directed learning means that learners themselves take the initiative in their own learning, diagnose learning needs, set learning goals, secure human and material resources necessary for learning, and select and implement appropriate learning strategies. That is, self-directed learning refers to a series of learning processes in which learners autonomously evaluate and provide feedback on learning results they have achieved. Self-directed learning is based on metacognitive ability, which is the ability of learners to recognize what and how much they do not know, make specific plans for how to learn, and execute them.

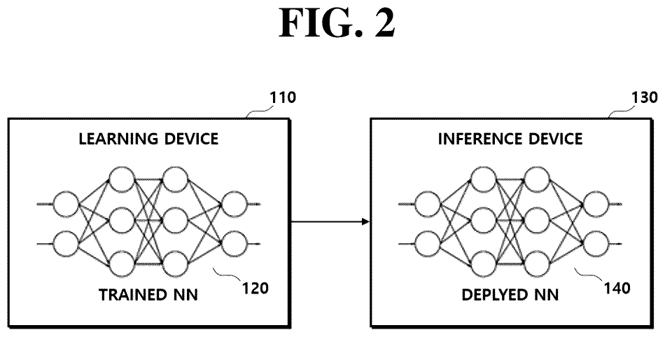

FIG. 2 is a view for explaining a reinforcement learning system according to an embodiment.

Referring to FIG. 2, the reinforcement learning system according to an embodiment may include a learning device 110 and an inference device 130. The learning device 110 according to an embodiment corresponds to a computing device having various processing functions such as functions for generating a neural network, training (or learning) a neural network, or retraining a neural network. For example, the learning device 110 may be implemented by various types of devices such as a personal computer (PC), a server device, and a mobile device.

The learning device 110 may repeatedly train (learn) a given initial neural network to generate a trained neural network 120. Generating the trained neural network 120 may mean determining neural network parameters. Here, the parameters may include various types of data input/output to/from a neural network, such as input/output activations, weights, and biases of the neural network. As the repetitive training of the neural network progresses, the parameters of the neural network may be tuned to compute a more accurate output for a given input.

The learning device 110 may transmit the trained neural network 120 to the inference device 130. The inference device 130 may be included in a mobile device, an embedded device, etc. The inference device 130 may be dedicated hardware for driving a neural network.

The inference device 130 may drive the trained neural network 120 as it is, or drive a neural network 140 obtained by processing (e.g., quantizing) the trained neural network 120. The inference device 130 that drives the processed neural network 140 may be implemented in a separate, independent device from that of the learning device 110. However, the disclosure is not limited thereto, and the inference device 130 may also be implemented in the same device as that of the learning device 110.

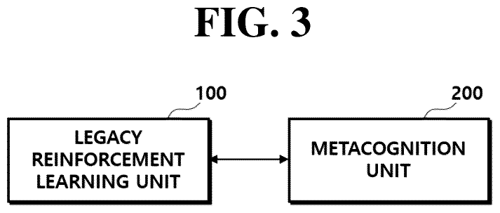

FIG. 3 is a block diagram of a deep reinforcement learning framework according to an embodiment. Referring to FIG. 3, the descriptions with reference to FIGS. 1 and 2 may be equally applied to FIG. 3.

Referring to FIG. 3, the deep reinforcement learning framework according to an embodiment may include a legacy reinforcement learning unit 100 and a metacognition unit 200. Hereinafter, terms such as “ . . . unit”, “-er”, and “-or” refer to units that perform at least one function or operation, and the units may be implemented as hardware or software or as a combination of hardware and software.

Through the deep reinforcement learning framework according to an embodiment, an agent (e.g., the agent 10 of FIG. 1) may not only maximize rewards through simple interaction with an environment, but also autonomously adjust its own learning process through metacognitive ability.

The legacy reinforcement learning unit 100 according to an embodiment may be designed based on the existing reinforcement learning methodology so that an agent may learn an optimal policy for maximizing rewards while interacting with an environment. The legacy reinforcement learning unit 100 may be composed of a reinforcement learning environment, a policy network, and a memory for reproduction.

An agent may select an action according to a given state in the reinforcement learning environment, and may receive a reward as a result of the selected action. Through this, the agent may adjust its action to maximize rewards. For example, an agent controlling an autonomous vehicle may select an action to avoid an obstacle or control the speed while driving, and may receive a reward as a result.

The agent's action selection may be determined through a policy network 101, and the policy network 101 may output an optimal action in a given state. A neural network-based policy network may learn from data experienced by an agent and determine the most appropriate action in a given situation. For example, a policy network of an autonomous vehicle may receive data such as the vehicle's speed, driving direction, and distance from obstacles, and select an optimal action in that situation.

Agent's experience of interacting with an environment, such as a state, action, reward, and next state, may be stored in a memory for reproduction. The memory for reproduction may store data experienced by an agent in the past and reuse it for later learning. Through this, the agent may learn better action policies by repeatedly learning past experiences. For example, an autonomous vehicle may store driving experiences in various road conditions such as rain or snow in a memory for reproduction and improve driving performance by repeatedly learning them.

The metacognition unit 200 according to an embodiment is a component designed to recognize extrinsic and intrinsic uncertainties in a learning process of an agent and adjust learning based on this. When an agent interacts with an environment, a metacognition unit may evaluate an agent's learning state and take actions to maximize learning efficiency. The metacognition unit encourages an agent to take the initiative in learning during a learning process, explore a new state, or repeatedly learn actions it is not sure about.

The metacognition unit 200 according to an embodiment performs a function of determining extrinsic uncertainty when an agent encounters a new state in an environment. Extrinsic uncertainty may refer to uncertainty that occurs when an agent faces a new state or a state that has not been experienced before. The metacognition unit 200 may evaluate whether a current state is a state that an agent has learned by comparing an agent's previously learned experience with the current state. In this process, the metacognition unit 200 may reconstruct the current state using an auto-encoder and determine how similar the reconstructed state is to a previously trained state. If a reconstruction error is large, the metacognition unit 200 may recognize the current state as a new state and provide an exploration reward to the agent so that the agent may explore the current state. This allows the agent to explore more untrained states and gain learning opportunities in a new environment. For example, when an autonomous vehicle enters a road on which it is driving for the first time, the metacognition unit 200 may induce an agent to explore this new road state.

The metacognition unit 200 according to an embodiment, when an agent selects an action in a specific state, may determine intrinsic uncertainty that evaluates the degree of confidence in the action. Intrinsic uncertainty may refer to uncertainty that arises when an agent is not sure about an action it has chosen based on what the agent has already learned. The metacognition unit 200 may measure how confident an agent is about an action selected in a corresponding state using a Monte-Carlo dropout technique or an ensemble technique. If the agent is determined to be insufficiently confident or highly uncertain about the action, the metacognition unit 200 may store a corresponding experience in the memory for reproduction. This experience with high uncertainty may be preferentially trained in future learning, and repeated learning opportunities may be provided so that the agent may be confident. For example, if an autonomous vehicle is unsure when attempting to change lanes at a complex intersection, the metacognition unit 200 may recognize this as a high uncertainty experience, and may help the autonomous vehicle act with more confidence by repeatedly learning this experience.

In addition, the metacognition unit 200 may store experiences with high uncertainty in the memory for reproduction, and then reconstruct them to utilize them for learning. The metacognition unit 200 may filter experiences that need to be preferentially trained based on intrinsic uncertainty, and set them as important experiences in the memory for reproduction. This allows an agent to repeatedly learn a high uncertainty experience, and gradually reduce uncertainty and gain the ability to make better decisions. For example, an autonomous vehicle may make more reliable determination in complex situations through multiple learning sessions.

In summary, the metacognition unit 200 grants an agent the autonomy to recognize its own uncertainty during learning and adjust its learning strategy based on this. The agent explores a new state through extrinsic uncertainty and increases confidence through intrinsic uncertainty by repeated learning. This allows the agent to learn more actively and acquire learning capabilities that may maintain stable performance in various situations.

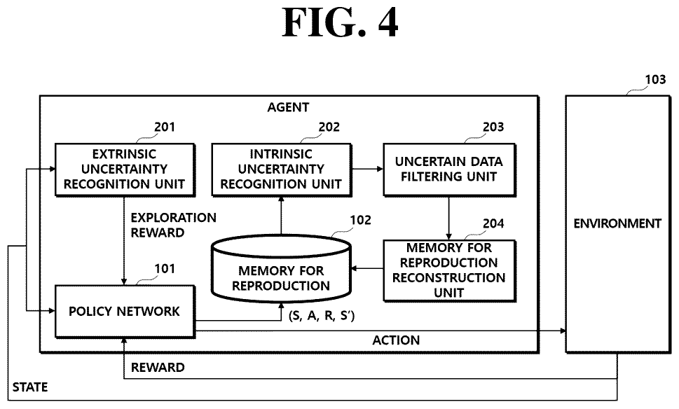

FIG. 4 is a view illustrating a structure of a deep reinforcement learning framework according to an embodiment. The descriptions with reference to FIGS. 1 to 3 may be equally applied to FIG. 4.

Referring to FIG. 4, the deep reinforcement learning framework according to an embodiment may include the legacy reinforcement learning unit 100 and the metacognition unit 200. The legacy reinforcement learning unit 100 may include a reinforcement learning environment 103 for learning of an agent, the policy network 101 that learns an optimal action policy according to a given state in the reinforcement learning environment 103, and a memory for reproduction 102 in which a transaction of the policy network 101 is stored. A transaction according to an embodiment is a bundle of data generated when an agent interacts with an environment, and may be composed of a state, action, reward, and next state S′.

The metacognition unit 200 according to an embodiment may include an extrinsic uncertainty recognition unit 201 that determines whether a given state is familiar or not (i.e., how uncertain the given state is) and provides it as an exploration reward during learning of a policy network, an intrinsic uncertainty recognition unit 202 that recognizes a transaction with high agent uncertainty from among transactions stored in the memory for reproduction 102, an uncertain data filtering unit 203 that refines the transaction recognized by the intrinsic uncertainty recognition unit 202, and a memory for reproduction reconstruction unit 204 that sets a memory for reproduction so that filtered data may be trained preferentially. However, the elements, shown in FIG. 4, are not essential elements. The deep reinforcement learning framework may be implemented by using more or less elements than those shown in FIG. 4.

The agent may start learning by receiving a state from the reinforcement learning environment 103. The state contains information about a current environment of the agent, and for example, an autonomous vehicle may include various information such as a state of a road, a location of other vehicles, and traffic signals. Based on this state information, the agent selects an optimal action through the policy network 101. The policy network 101 may be implemented as a neural network and may output an action that may maximize rewards in a given state. In an example of an autonomous vehicle, a policy network may select an action such as lane change and speed control.

The action selected by the agent is applied to an environment, inducing a change in the environment, and accordingly, the agent may obtain a reward. The reward is given when the action performed by the agent has a positive effect on the environment. For example, if the autonomous vehicle safely completes a lane change, the agent may receive a high reward. On the other hand, if it fails, the reward may decrease or be negative. These experiences are recorded as state, action, reward, and next state S′, and may be stored in the memory for reproduction 102. The memory for reproduction 102 stores and manages past experiences, and may be used as data for repeated learning of these experiences when an agent learns later.

The legacy reinforcement learning unit 100 according to an embodiment may perform a basic reinforcement learning process, and the metacognition unit 200 may supplement this by providing an additional learning process for an agent to recognize uncertainty during learning and resolve it.

An operation of the extrinsic uncertainty recognition unit 201, when an agent faces a new state, may be performed by evaluating whether the state is a previously trained state and granting an exploration reward based on this. To this end, the extrinsic uncertainty recognition unit 201 may analyze the state using an auto-encoder.

The auto-encoder compresses input state data into a low-dimensional latent space and then reconstructs it to the original state. In this process, the auto-encoder may reconstruct data with very high accuracy for a state that has already been trained. However, a reconstruction error may occur for a state that has not been trained previously. The larger the reconstruction error, the more likely it is that the state is a new state that an agent has not experienced before.

The extrinsic uncertainty recognition unit 201 may determine whether the state is a new state based on this reconstruction error of the auto-encoder. In more detail, when an agent encounters a current state, the state may be reconstructed by inputting the state into the auto-encoder. If a reconstruction error is very small, this may be interpreted as the agent already having learned about the state. On the contrary, if the reconstruction error is large, this may mean that the agent is faced with a new state.

Once the determination on the new state is complete, the extrinsic uncertainty recognition unit 201 may provide the agent with an exploration reward. The exploration reward may be an additional reward that encourages the agent to further explore states that have not been previously trained. For example, when an autonomous vehicle drives on a new road section, the extrinsic uncertainty recognition unit 201 may recognize that the road has different characteristics from previously trained roads. At this time, the auto-encoder outputs a high reconstruction error for the new road, and the extrinsic uncertainty recognition unit 201 may provide an exploration reward based on this.

The exploration reward may be added to an agent's base reward to motivate the agent to actively explore new state. For example, if an autonomous vehicle successfully completes driving on a new road, an agent may obtain an additional exploration reward in addition to the existing reward. This reward serves to encourage an agent to accumulate more experience in a new state that the agent has not yet learned.

Therefore, the extrinsic uncertainty recognition unit 201 may play an important role in supporting an agent to effectively detect a new state and explore the state more. This may help the agent expand learning in various environments and adapt well to unexpected new situations.

Furthermore, the metacognition unit 200 may evaluate whether an agent is confident about an action it has chosen through the intrinsic uncertainty recognition unit 202. Intrinsic uncertainty occurs when an agent selects an action in a specific state, and may measure how confident the agent is about the action. The intrinsic uncertainty recognition unit 202 may use the Monte-Carlo dropout technique or the ensemble technique to evaluate the agent's confidence in an action it has chosen, and recognize a lack of confidence in the agent as intrinsic uncertainty.

The Monte-Carlo dropout technique is a method of estimating uncertainty of an agent by activating dropout during a prediction process of a neural network. General dropout is used to randomly deactivate specific neurons to prevent overfitting of a neural network during a learning process, but the Monte-Carlo dropout technique may also be applied during a prediction stage. As a result, the neural network produces multiple prediction values through various paths, and by analyzing these prediction values, it is possible to measure how confident an agent is about its actions.

In more detail, the intrinsic uncertainty recognition unit 202 may perform multiple predictions for an identical state. For example, when a situation is given where an autonomous vehicle needs to choose one action between turning left or going straight at an intersection, the Monte-Carlo dropout technique is applied so that a neural network generates multiple predictions for turning left and going straight through different prediction paths. At this time, result values of respective predictions may vary slightly, and variance of these values represents uncertainty of an agent. If the variance of these values is small, it may mean that the agent is highly confident about the action. On the contrary, if the variance is large, it may mean that the agent is not confident about the action. The intrinsic uncertainty recognition unit 202 quantitatively calculates the degree of uncertainty and stores experiences with high uncertainty in the memory for reproduction 102 for later learning.

Furthermore, the intrinsic uncertainty recognition unit 202 may also evaluate the intrinsic uncertainty through the ensemble technique. The ensemble technique is a method of performing multiple predictions in an identical state by using multiple different neural network models in parallel. Because the neural network models are trained through different initial weights or learning data, respectively, they may make different predictions in an identical state. For example, let's assume that an autonomous vehicle needs to decide whether to turn left or right in a certain situation. The ensemble technique allows multiple neural network models to perform predictions in an identical state, and evaluates how consistently prediction values of the models appear. If most of the models predict a left turn, an agent has high confidence in a corresponding action. However, if the predictions of the models are different from each other, this indicates that the agent has uncertainty in the situation.

The intrinsic uncertainty recognition unit 202 may evaluate the degree of agreement between prediction values given by multiple models for an identical state using the ensemble technique. If the predictions of the models match, it may indicate that an agent has high confidence in a corresponding action, and if the predictions are inconsistent or significantly different, it may indicate that uncertainty is high and that additional learning is necessary.

Based on the uncertainty evaluation results, the intrinsic uncertainty recognition unit 202 filters out a high uncertainty experience and stores them in the memory for reproduction 102, and allows the agent to repeatedly learn the experiences in the future. This allows the agent to perform more learning in a state of high uncertainty and gradually increase its confidence in that state.

The metacognition unit 200 may process the stored high uncertainty experience through the uncertain data filtering unit 203, and reconstruct the memory for reproduction 102 based on this. Because the agent needs to repeatedly learn the high uncertainty experience, it can be given a high priority in a filtering process. Through this, data classified as important experiences in the memory for reproduction 102 may be used more frequently in an agent's additional learning process. For example, an autonomous vehicle repeatedly learns a corresponding experience to increase its confidence in changing lanes at a complex intersection, and through this, an agent gradually acquires the ability to make better decisions.

The memory for reproduction reconstruction unit 204 reconstructs the memory for reproduction 102 based on filtered data, and through this, an agent may repeatedly learn a high uncertainty experience. In an example of an autonomous vehicle, as experience with lane changes at intersections or complex road situations is trained repeatedly, an agent may choose actions with greater confidence in those situations. This iterative learning allows an agent to perform more stable learning while gradually reducing uncertainty.

In conclusion, the metacognition unit 200 recognizes uncertainty that occurs when an agent interacts with an environment and additionally provides a learning process to resolve it, thereby helping the agent to learn more autonomously and efficiently. The agent may gradually improve its learning performance by exploring a new state through extrinsic uncertainty and repeatedly learning uncertain actions through intrinsic uncertainty. Through this, the agent may implement stable and adaptive learning in various environments.

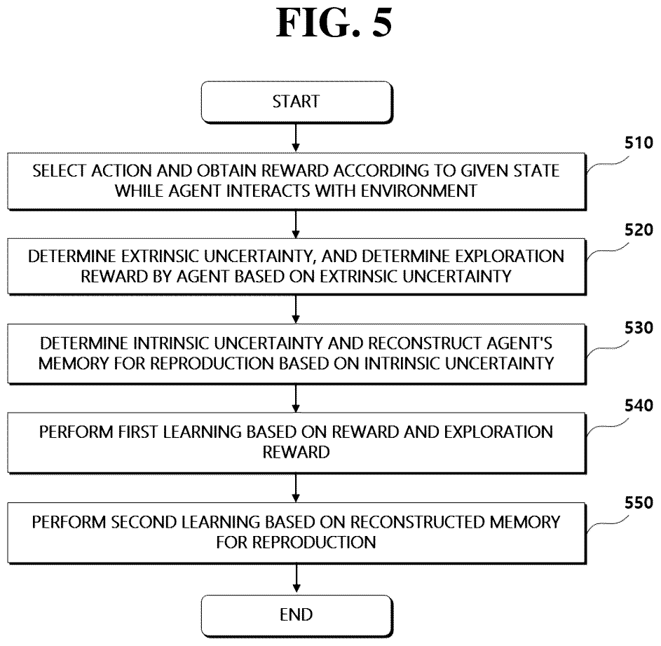

FIG. 5 is a flowchart explaining a reinforcement learning method according to an embodiment. The descriptions with reference to FIGS. 1 to 4 may be equally applied to FIG. 5.

For convenience of explanation, operations 510 to 550 are described as being performed using the learning device 110 shown in FIG. 2. However, these operations 510 to 550 may be used via any other suitable electronic device and within any suitable system.

In addition, operations of FIG. 5 may be performed in the illustrated order and manner, but the order of some operations may be changed or some operations may be omitted without departing from the spirit and scope of the illustrated embodiment. A number of operations shown in FIG. 5 may be performed in parallel or concurrently.

The reinforcement learning method according to an embodiment aims to maximize learning efficiency by combining a metacognitive element with a traditional reinforcement learning process in which an agent selects an action and obtains a reward according to a state while interacting with an environment. The agent may determine uncertainty of a state it is in, encourage new exploration to resolve this uncertainty, or reconstruct trained experiences to gain an opportunity to learn more deeply.

Referring to FIG. 5, in operation 510, the learning device 110 may select an action and obtain a reward according to a given state while an agent interacts with an environment. For example, an agent of an autonomous vehicle agent may detect a current road condition, traffic signals, surrounding vehicles, etc., and select an appropriate driving action accordingly. At this time, the autonomous vehicle receives a reward for safely passing through an intersection.

In operation 520, the learning device 110 may determine extrinsic uncertainty, and the agent may determine an exploration reward based on the extrinsic uncertainty. If the agent inputs a current state into an auto-encoder and reconstructs it, and a reconstruction error is small, this means that the agent has already learned the state. On the contrary, if the reconstruction error is large, this means that the agent has encountered a new state. For example, when an autonomous vehicle encounters a road for the first time, an auto-encoder may show a high reconstruction error for a state of the road.

When such a new state is detected, an exploration reward is determined based on extrinsic uncertainty. An extrinsic uncertainty recognition unit may provide an additional reward to encourage an agent to explore a new state that it has not experienced before. For example, when an autonomous vehicle safely passes a new road section, an agent obtains an exploration reward in addition to the existing reward. This allows the agent to more actively explore untrained states and expand its experience in a new environment.

In operation 530, the learning device 110 may determine intrinsic uncertainty and reconstruct an agent's memory for reproduction based on the intrinsic uncertainty. The learning device 110 may evaluate confidence in its own action by determining the intrinsic uncertainty. In this process, the Monte-Carlo dropout technique or the ensemble technique is used. When an agent selects an action in a specific state, it performs multiple predictions through these techniques. If results of performing multiple predictions in the same state are consistent, the learning device 110 may determine that the agent has high confidence in the action. However, if variance of predicted values is large or the predictions are inconsistent, it means that the agent is not sure about the action, and the learning device 110 recognizes this as intrinsic uncertainty. For example, if an autonomous vehicle is not sure whether to go straight or turn left at an intersection, an intrinsic uncertainty recognition unit records this experience as a state of high uncertainty.

The learning device 110 reconstructs the memory for reproduction based on intrinsic uncertainty. Experiences with high uncertainty are preferentially stored in the memory for reproduction and filtered for additional learning. A memory for reproduction reconstruction unit may filter out such data with high uncertainty to induce an agent to repeatedly learn the experiences. Through this, the learning device 110 may learn more about an action that an agent was not confident about, and gradually increase the confidence in the action.

In operation 540, the learning device 110 may perform first learning based on a reward and the exploration reward. In a first learning operation, a policy is updated based on a reward and exploration reward obtained while an agent interacts with an environment. For example, when an autonomous vehicle completes driving on a new road and receives an exploration reward, this may improve an action policy on the road. The first learning may be performed in real time.

In operation 550, the learning device 110 may perform second learning based on the reconstructed memory for reproduction. When experiences with high uncertainty are stored in the memory for reproduction, the agent performs additional learning based on these experiences. This allows the agent to repeatedly learn from past actions in which it was less confident, and thus make progressively better decisions. For example, when an autonomous vehicle attempts to make a left turn at a complex intersection with high uncertainty, it may repeatedly learn a corresponding experience from the memory for reproduction to make a left turn with increasingly higher confidence. The second learning may be performed periodically.

A weight between the first learning and the second learning may be dynamically adjusted to improve the agent's learning efficiency and uncertainty. In the disclosure, by setting relative importance of the first learning and the second learning differently depending on the situation, an agent may be made to exhibit optimal learning performance.

First, the first learning is a process in which an agent learns based on a reward and exploration reward obtained while interacting with an environment in real time. This learning process allows an agent to explore a new state in an environment in real time and receive immediate feedback on the state to update a policy. In contrast, the second learning is a process in which an agent repeatedly learns experiences with high intrinsic uncertainty, and performs additional learning based on an experience stored in the reconstructed memory for reproduction. This process helps the agent reduce uncertainty in a state it has already explored and select better actions.

A weight between the two learnings may be set differently depending on an agent's learning stage, the degree of uncertainty, and the complexity of an environment. For example, in an early stage of learning, a weight of the first learning may be set relatively high because the agent needs to explore more unexplored states. At this time, the agent may focus on exploring a new state in an environment and quickly learning a policy for the state.

On the other hand, if the agent repeatedly experiences uncertainty in a specific state, a weight of the second learning may be set higher. In this situation, it may be important to repeatedly learn experiences with high uncertainty to increase confidence in the specific state. For example, if an autonomous vehicle becomes uncertain about changing lanes at an intersection, the weight of the second learning may be set higher to induce repeated learning of a corresponding experience.

In addition, as learning progresses, after an agent has sufficiently explored states in an environment, the weight of the first learning may decrease and the weight of the second learning may gradually increase. This is because additional learning about the states explored by the agent may become more important. Experiences with high uncertainty are repeatedly trained in the reconstructed memory for reproduction, which allows an agent to select an action with more confidence.

In the disclosure, such weight adjustment may be performed dynamically and may be automatically set according to a specific criterion or threshold. For example, if an agent experiences uncertainty in an identical state a certain number of times or more, the weight of the second learning may increase. On the contrary, the weight of the first learning may increase as the proportion of exploration rewards received in a new state increases. In this way, the agent may appropriately distribute learning resources according to a situation to maintain optimal learning performance.

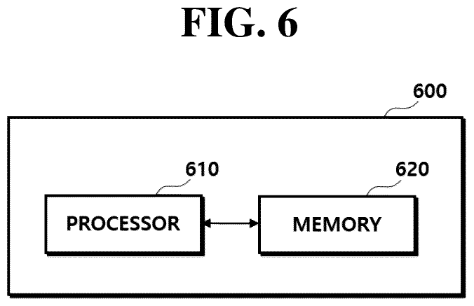

FIG. 6 is a block diagram of an electronic device according to an embodiment. The descriptions with reference to FIGS. 1 to 5 may be equally applied to FIG. 6.

Referring to FIG. 6, an electronic device 600 according to an embodiment may include a processor 610 and a memory 620. However, the elements, shown in FIG. 6, are not essential elements. The electronic device 600 may be implemented by using more or less elements than those shown in FIG. 6. For example, the electronic device 600 may further include a sensor unit.

A reinforcement learning system according to an embodiment may be performed through the electronic device 600, through which an agent may interact with a physical environment in real time and perform learning. Each component of the agent may be implemented as hardware such as an electronic circuit, a processing unit, and a memory device, through which rapid and efficient learning processing may be enabled. For example, the agent may learn and execute a neural network-based policy network using the processor 610 such as a central processing unit (CPU), a graphic processing unit (GPU), or a dedicated artificial intelligence (AI) accelerator. For example, in a physical system such as an autonomous vehicle, a high-performance GPU or AI accelerator may be used to process complex neural network operations in real time to quickly determine agent's actions. This hardware may handle calculations essential for the agent to process a given state and select an optimal action.

In addition, the memory 620 may be used to physically implement a memory for reproduction of the agent. The memory for reproduction may be implemented through non-volatile memory or high-speed accessible RAM on the hardware, which allows the agent to store previous experiences and perform iterative learning. For example, an agent in an autonomous vehicle may store data about various road conditions collected during driving in the memory 620 and retrieve and learn the data whenever necessary. In this process, the memory 620 may preferentially store experiences with high uncertainty and quickly provide data for iterative learning.

Furthermore, the reinforcement learning method of the disclosure may be closely integrated with a hardware-based sensor network. In a physical system such as an autonomous vehicle, a state of an environment may be recognized in real time through a sensor such as a camera, LiDAR, and radar, and state information of an agent may be collected based on this. The state information is transmitted to a hardware processing unit and quickly analyzed, and the agent may select appropriate actions accordingly. For example, an agent of an autonomous vehicle may detect a traffic flow at an intersection through a camera, process it through a GPU, and then determine an optimal driving path in a policy network.

In addition, a computational work required for an exploration reward and additional learning may also be performed in the processor 610. Complex neural network operations such as auto-encoders or Monte-Carlo dropouts may be processed in parallel through high-performance hardware, and through this, the agent may evaluate uncertainty in real time and quickly perform a computation required for an exploration reward or additional learning.

Hardware-based implementation of the disclosure may support an agent to perform learning in a physical environment more effectively and quickly. Through this, the agent may be equipped with the ability to analyze a state in real time, determine uncertainty, and select an optimal action. The electronic device 600 according to an embodiment may operate in real time and efficiently in various application fields such as autonomous vehicles, robot systems, and smart factories.

The embodiments described above may be implemented by hardware components, software components, and/or any combination thereof. For example, the devices, the methods, and components described in the embodiments may be implemented by using general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other devices which may execute and respond to instructions. A processing apparatus may execute an operating system (OS) and a software application executed in the OS. Also, the processing apparatus may access, store, operate, process, and generate data in response to the execution of software. For convenience of understanding, it may be described that one processing apparatus is used. However, one of ordinary skill in the art will understand that the processing apparatus may include a plurality of processing elements and/or various types of processing elements. For example, the processing apparatus may include a plurality of processors or a processor and a controller. Also, other processing configurations, such as a parallel processor, are also possible.

The software may include computer programs, code, instructions, or any combination thereof, and may construct the processing apparatus for desired operations or may independently or collectively command the processing apparatus. In order to be interpreted by the processing apparatus or to provide commands or data to the processing apparatus, the software and/or data may be permanently or temporarily embodied in any type of machines, components, physical devices, virtual equipment, computer storage mediums, or transmitted signal waves. The software may be distributed over network coupled computer systems so that it may be stored and executed in a distributed fashion. The software and/or data may be recorded in a computer-readable recording medium.

A method according to an embodiment may be implemented as program instructions that can be executed by various computer devices, and recorded on a computer-readable recording medium. The computer-readable recording medium may include program instructions, data files, data structures or a combination thereof. Program instructions recorded on the medium may be particularly designed and structured for embodiments or available to one of ordinary skill in a field of computer software. Examples of the computer-readable recording medium include magnetic media, such as a hard disc, a floppy disc, and magnetic tape; optical media, such as a compact disc-read only memory (CD-ROM) and a digital versatile disc (DVD); magneto-optical media, such as floptical discs; and hardware devices specially configured to store and execute program instructions, such as ROM, random-access memory (RAM), a flash memory, etc. Program instructions may include, for example, high-level language code that can be executed by a computer using an interpreter, as well as machine language code made by a complier.

In concluding the detailed description, those of ordinary skill in the art will appreciate that many variations and modifications may be made to the embodiments without substantially departing from the principles of embodiments of the present invention. Therefore, the disclosed embodiments of the invention are used in a generic and descriptive sense only and not for purposes of limitation.

What is claimed is:

1. A deep reinforcement learning framework, comprising:
a reinforcement learning environment that provides an environment with which an agent interacts;
a policy network that learns an optimal policy through trial and error in which the agent selects an action based on a given state in the reinforcement learning environment and obtains a reward as a result of the action;
a memory for reproduction that stores information about a state, action, reward, and next state generated by the agent interacting with the reinforcement learning environment;
an extrinsic uncertainty recognition unit that determines extrinsic uncertainty based on agent's metacognitive ability and detects a new state to provide an additional exploration reward;
an intrinsic uncertainty recognition unit that evaluates intrinsic uncertainty of transactions generated by the policy network;
an uncertainty data filtering unit that selects a transaction with high uncertainty based on an evaluation result of the intrinsic uncertainty recognition unit; and
a memory for reproduction reconstruction unit that reconstructs the memory for reproduction based on the selected transaction to optimize repeated learning of the agent.

2. The deep reinforcement learning framework of claim 1, wherein the extrinsic uncertainty recognition unit calculates a reconstruction error using an auto-encoder to detect the new state from the given state by the agent, and if the reconstruction error is large, the given state is determined as the new state and the additional exploration reward is provided.

3. The deep reinforcement learning framework of claim 1, wherein the intrinsic uncertainty recognition unit evaluates degree of confidence in each action of the transactions generated by the policy network using a Monte-Carlo dropout technique or an ensemble technique.

4. The deep reinforcement learning framework of claim 1, wherein the memory for reproduction is configured to:
periodically store information about a state, action, reward, and next state generated by the agent interacting with the reinforcement learning environment, and
the stored information is readjusted in priority by the memory for reproduction reconstruction unit.

5. The deep reinforcement learning framework of claim 1, wherein the policy network learns an action policy in real time based on the reward obtained by the agent in the reinforcement learning environment and the additional exploration reward.

6. The deep reinforcement learning framework of claim 1, wherein the transaction stored in the memory for reproduction is reconstructed by the memory for reproduction reconstruction unit and then repeatedly trained in the policy network so that an action policy of the agent is optimized.

7. The deep reinforcement learning framework of claim 1, wherein the uncertainty data filtering unit is configured to:
filter the transaction according to an evaluation result of the intrinsic uncertainty recognition unit; and
preferentially transmit the transaction with high uncertainty to the memory for reproduction reconstruction unit.
